(19) United States
(12) Patent Application Publication
(10) Pub. No.: US 2003/0191938 A1
(43) Pub. Date: Oct. 9, 2003

(54) Computer security system and method

(75) Inventors: Stephen Robert Woods, Hampshire (GB); Philip Carl Charette, Ipswich, MA (US)

Correspondence Address: OSTROLENK FABER GERB & SOFFEN, 1180 AVENUE OF THE AMERICAS, NEW YORK, NY, 100368403

(73) Assignee: Solarsoft Ltd.

(21) Appl. No.: 10/119,438

(22) Filed: Apr. 9, 2002

(51) Int. Cl. H04L 9/00

(52) U.S. Cl. 713/165

(57) ABSTRACT

A secure processing system provides for the encryption of files by compression of the content of files and encryption of the compressed content. Also, files can be obfuscated by changing their file name and location and keeping a record of the changes encrypted for them. The encryption and stealth features can be made accessible by a simple graphical user interface accessible by a password to provide for simple operation.

### FIELD OF THE INVENTION

The present invention generally relates to a computer security system and method for securing information such as files stored within the computer system.

### BACKGROUND OF THE INVENTION

A great deal of focus is placed in the prior art on the problem of improving computer security by preventing unauthorized access to a computer system, for example by hackers over a network such as the Internet. This focus does not, however, address the problem of providing security once someone has accessed the computer. For example, within a company, many employees may have access to a computer system but it is necessary to provide a level of security for information on the computer system.

### SUMMARY OF THE INVENTION

The first aspect of the present invention provides a secure method and system for encrypting files in which the content of the files are initially compressed and then encrypted.

This aspect of the present invention provides for the secure encryption of files since the compression process improves the security by removing potential patterns in the file content which could weaken the strength of the encryption.

In a preferred embodiment the compression comprises run length encoding of the content of the file.

In another embodiment the compression includes the identification of a file header in the content of the file and of obfuscation of the file header before encryption. The obfuscation can comprise modifying, moving or deleting the file header.

In a preferred embodiment the encryption is performed using symmetric key encryption and in one embodiment the encryption key is based on a user input password.

This aspect of the present invention also includes a method and system for decrypting the content of an encrypted file in which the file content is decrypted and then decompressed.

Another aspect of the present invention provides a method and system for obfuscating at least one file in a computer system in which a file name of the or each file is automatically changed from an original file name to an obscure file name and the or each file is moved from an original location to at least one obscure location. A record of the or each original file name and location and the or each corresponding obscure file name and location is kept in encrypted form.

Thus in accordance with this aspect of the present invention files can be obfuscated or hidden by changing their file name and moving them automatically. The new file name is chosen to be obscure, i.e. a non-obvious file name such as a random or pseudo-random file name. Also the location of the files is chosen to be obscure so as to make it less obvious where the files may be should someone attempt to locate and read them.

In a preferred embodiment the locations comprise directories or folders in a computer system.

In one embodiment a user can select the or each directory or folder for the obfuscation of files. In one embodiment the user can then select the files for obfuscation. In an alternative embodiment, files within the directory or folder are automatically selected. This selection can be based on file type, e.g. encrypted files, or all files within the folder or directory can be obfuscated automatically.

This aspect of the present invention also provides a method and apparatus for recovering at least one obfuscated file in a computer system in which a record of at least one original file name and location and at least one corresponding obscure file name and location is read and decrypted. The file name of the or each obfuscated file is then automatically changed from the or each obscure file name to the or each original file name and the or each file is moved from the respective obscure location to the respective original location.

Thus in this aspect of the present invention, obfuscated files can be recovered.

In a preferred embodiment a user makes a selection of the or each original directory or folder. This requires the user to remember the or each directory or folder in which the original file was stored. This provides an element of security since it requires the user to remember something. When a user enters the selection, this can be used to identify at least one corresponding obscure file name and directory or folder in the decrypted record. The or each corresponding obscure file name is then automatically changed to the or each original file name and the or each corresponding file is moved from the respective obscure directory or folder to the respective original directory or folder.

Another aspect of the present invention provides a method and system for obfuscating information stored in a location in a computer system. The information is divided into a plurality of segments and each segment is stored in a new location. A record of the location of the information and corresponding new locations is kept in encrypted form. The original information is then deleted, preferably securely.

Thus in accordance with this aspect of the present invention, a secure obfuscation method and system is provided since even if an unauthorized person were able to identify a file, this would only represent a segment of the data in the original file.

In one embodiment to further improve the level of obfuscation, the segments are of random or pseudo-random size. Also, in a preferred embodiment a number of the segments can be inverted, i.e. written backwards, before being stored. In this case the record includes information identifying which segments are stored in inverted form to facilitate the reconstruction of the original information.

Information to be encrypted can be based on a user selection of the location and of the actual information. Alternatively, the information to be obfuscated can be automatically determined based solely on a user selection of the location of information.

In a preferred embodiment the information comprises a file having a file name and the location is identified by a directory or folder name. Also the record includes the file name and directory or folder. In this embodiment each segment can be stored as a file having a new file name in another directory or folder and the record can include the new files names and other directories and folders. The file names used for each segment can be randomly or pseudo-randomly generated as an obscure file name and the directory or folder in which each segment is stored can also be an obscure directory or folder, e.g. an operating system directory or program directory.

In an alternative embodiment of the present invention, the segments are stored in a form which is not recognisable by an operating system. Thus, the segments do not appear in any file menu or file location utility available in the computer operating system.

In a preferred embodiment to ensure increased security, the information is preferably encrypted before segmentation. The encryption method can, in one embodiment, comprise the encryption method of the first aspect of the present invention.

This aspect of the present invention enables any number of information items to be obfuscated by individual segmentation. In such a case the record includes the location of each information item and corresponding new locations of stored segments.

This aspect of the present invention also encompasses a method and system for restoring information obfuscated in a computer system. A record of an original location of the information and corresponding locations of segments of the information is read and decrypted. The segments of the information are read from the locations and combined to form the original information. The original information is then stored as the restored information in the original location.

Thus this aspect of the present invention encompasses the reverse process of obfuscation for restoration of obfuscated files.

A further aspect of the present invention provides a method of operating a computer system to provide file security and a computer system for the provision of file security in which a password input interface is generated requiring a password input from a user. An input password is compared with a stored password and a graphical user interface is generated displaying a file menu in dependence upon the comparison to allow a user to input a user selection of at least one file for encryption or decryption. In response to the user selection the or each selected file is encrypted or decrypted using symmetric key encryption or decryption and the input password comprises the basis of the key for encryption or decryption.

Thus in accordance with this aspect of the present invention a simple user interface is provided by which a user can only gain access to the security graphical user interface by the entry of a password. Once the password is entered a user need not enter a user password again in order to perform encryption/decryption operations. Such operations simply require the user to select files from a file menu.

In a preferred embodiment the graphical user interface is generated with a selectable option to allow a user to input a user selection of at least one file to be obfuscated and the or each file is obfuscated in response to the user selection. Thus in this embodiment of the present invention, the generated security graphical user interface allows a user to access a secure and simple method of both encrypting and obfuscating files. In this embodiment the graphical user interface can also include a selectable option to allow a user to input a user selection to restore obfuscated files. This selection can simply comprise the selection of a directory or folder in which files were originally contained for obfuscation and the restoration of the files into the original directory or folder will take place automatically.

A further aspect of the present invention provides a method of assisting an operator of a processing system and a processing system for providing operator assistance in which user inputs to the processing system are monitored during processing of a file by a processing application. The detection of when a processing application has finished processing a file takes place and at this point monitored user inputs are compared to a user profile. The user interface is generated in dependence upon the comparison to allow the user to select to encrypt the file. If a user selects to encrypt the file, the file is automatically encrypted.

Thus in accordance with this aspect of the present invention, a user is assisted or prompted to securely store files after processing of the files. This is achieved by monitoring user inputs and comparing these with a user profile.

In a preferred embodiment the monitored user inputs comprise key strokes and the comparison comprises comparing the monitored key strokes with words in the user profile.

The user profile can contain information on previous behaviour of a user such as keywords related to files that a user has previously encrypted. Thus, in other words, it determines an encryption behaviour for a user. Thus by monitoring the previous encryption selections it is possible to modify the user profile in accordance with the previous encryption behaviour of the user.

Any aspect of the present invention described hereinabove can be used in conjunction with any other aspect of the present invention to provide a secure processing system for a user.

The present invention can be implemented solely in hardware, in software controlling a general-purpose computer, or in a combination of specially configured hardware and software controlling programmable hardware. The present invention thus encompasses computer program code for controlling the processing system to implement the method of the present invention. The computer program code can be provided to the processing system on any suitable carrier medium such as a storage medium, e.g. a floppy disk, hard disk, CD-ROM, programmable memory device, or magnetic tape device, or a transient medium such as an electrical, optical, microwave, acoustic, or magnetic signal, e.g. a signal carrying computer code over a computer network such as the Internet.

### BRIEF DESCRIPTION OF THE DRAWINGS

FIG. 1 is a screen shot of a user interface for registering a user in accordance with an embodiment of the present invention;

FIG. 2 is a screen shot of the user interface for logging in to enter a user password in accordance with an embodiment of the present invention;

FIG. 3 is a screen shot of the user interface showing the file menu and the security options in accordance with an embodiment of the present invention;

FIG. 4 is a schematic diagram of a secure processing system in accordance with an embodiment of the present invention;

FIG. 5 is a screen shot of a graphical user interface showing the selection of files in the file menu for encryption of the files in accordance with an embodiment of the present invention;

FIG. 6 is a screen shot showing the interface following encryption of the files in accordance with an embodiment of the present invention;

FIG. 7 is a flow diagram illustrating the encryption process in accordance with an embodiment of the present invention;

FIG. 8 is a flow diagram illustrating the decryption process in accordance with an embodiment of the present invention;

FIG. 9 is a flow diagram illustrating a first stealth method in accordance with an embodiment of the present invention;

FIG. 10 is a flow diagram illustrating a first stealth restoration method in accordance with an embodiment of the present invention;

FIG. 11 is a flow diagram illustrating a second stealth method in accordance with an embodiment of the present invention;

FIG. 12 is a flow diagram illustrating a second stealth restoration method in accordance with an embodiment of the present invention; and

FIG. 13 is a flow diagram illustrating the monitoring process in accordance with an embodiment of the present invention.

### DESCRIPTION OF PREFERRED EMBODIMENTS

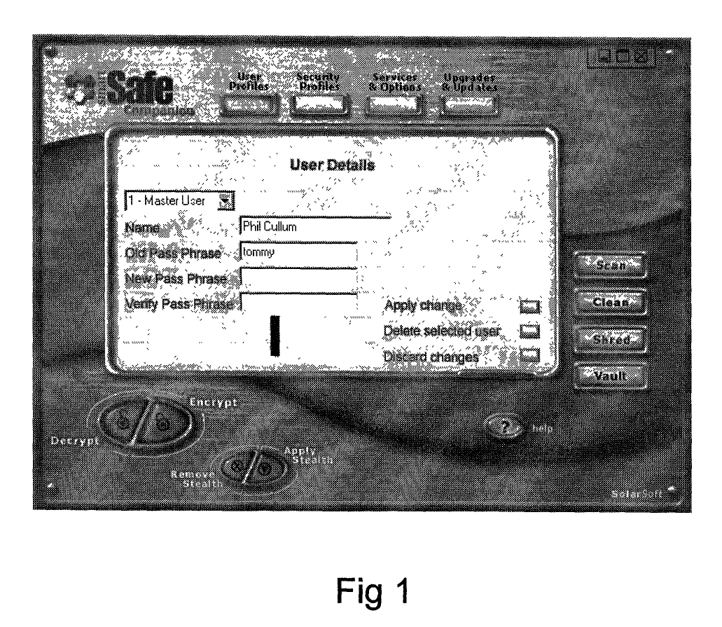

FIG. 1 illustrates a graphical user interface which is displayed when security software in accordance with an embodiment of the present invention is installed on a computer. The graphical user interface allows a user to enter their pass phrase, i.e. a sequence of passwords. In this embodiment of the present invention a pass phrase is used as the password rather than a single word password since the increased number of characters increases security.

The graphical user interface also allows the level of the user to be selected. A master user can be the default user when the software is first installed on a computer. The software can subsequently allow a number of installations on other computers whereupon users become sub-users. The master user can then have access to the pass phrases for these users to allow them access to files which have been secured using the security application as will be described in more detail hereinafter.

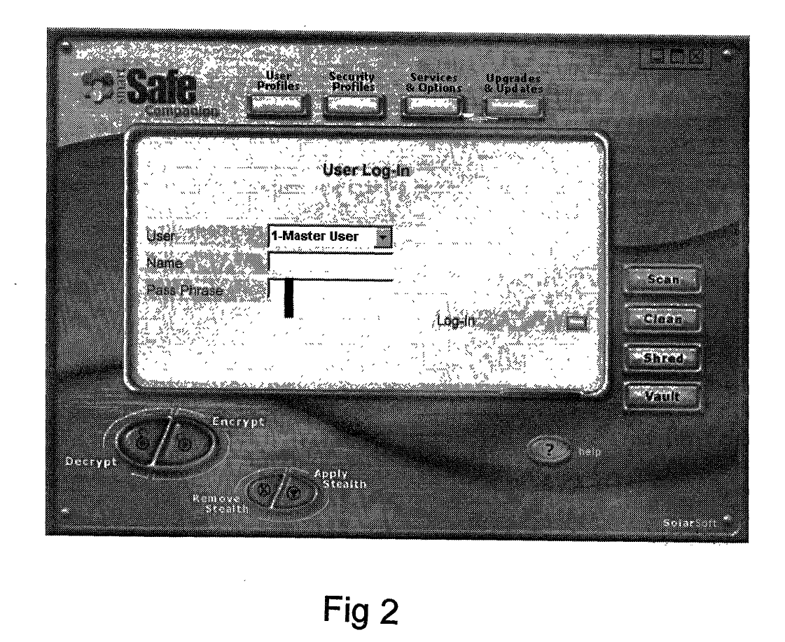

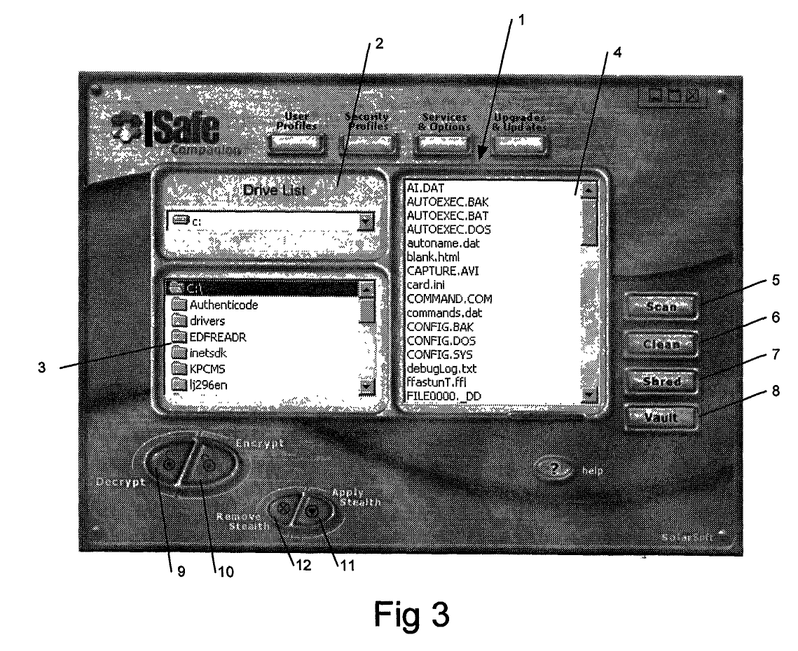

Once the security application has been installed, when a user wishes to execute the application, a log-in window is initially displayed as illustrated in FIG. 2. The log-in window requires a user to enter their name and pass phrase in order to open the security application. The user name and pass phrase are those entered by the user when installing the application and these are securely stored by the application so that a user can be authenticated. Thus a user can only access the security application user interface as illustrated in FIG. 3 by entering a pass phrase.

The graphical user interface illustrated in FIG. 3 is the user interface to security features provided by the security application. At the centre of the graphical user interface there is displayed a file menu window 1 which comprises a drive list section 2, a directory or folder list section 3 and a file list section 4. This type of file menu is conventional in Microsoft Windows (trade mark) type applications. A user is thus able to select files in various locations for security operations. A security interface, for example, enables a user to select using the scan button 5 to scan a directory or folder or disk drive for unauthorized material. A user can also select the clean button 6 when a disk drive is selected in the drive list window 2 to clean a hard disk, i.e. by removing temporary files, marking damaged clusters, etc. A user can also select the shred button 7 to shred files selected in the file window 4. The shred operation performs secure deletion by multiple overwrites of the sections of the hard disk on which the files are stored. A user can also select the vault button 8 to access a secure backup storage system at a server. The features provided by buttons 5 to 8 are not essential features for the present invention and merely provide additional utilities available from the graphical user interface provided by the security application.

The graphical user interface includes an encrypt button 10 and a decrypt button 9. When files are selected in the file window 4 the selected files will be encrypted or decrypted as appropriate.

The graphical user interface also provides an apply stealth button 11 and a remove stealth button 12. When these buttons are selected and a directory or folder is selected in the directory or folder window 3, files are “stealthed” or recovered in the selected directory. The stealth operation obfuscates or hides the files of a certain type that are contained in the selected directory. In this embodiment the files that are automatically selected for hiding or obfuscating in the selected directory are encrypted files. Thus in this embodiment only encrypted files are hidden. Thus the stealth operation provides a further level of security for files which are deemed to be sufficiently important to require encryption.

Although in this embodiment only encrypted files are obfuscated by the stealth operation, the present invention encompasses the obfuscation of any type of file. For example, the stealth process could automatically obfuscate all files in the selected directory or only files of a certain type. The file type need not require that the files be encrypted.

In order to recover files a user must remember and select the directory or folder that originally contained the obfuscated files using the folder or directory window 3. The user can then select the remove stealth button 12 and the files are automatically recovered.

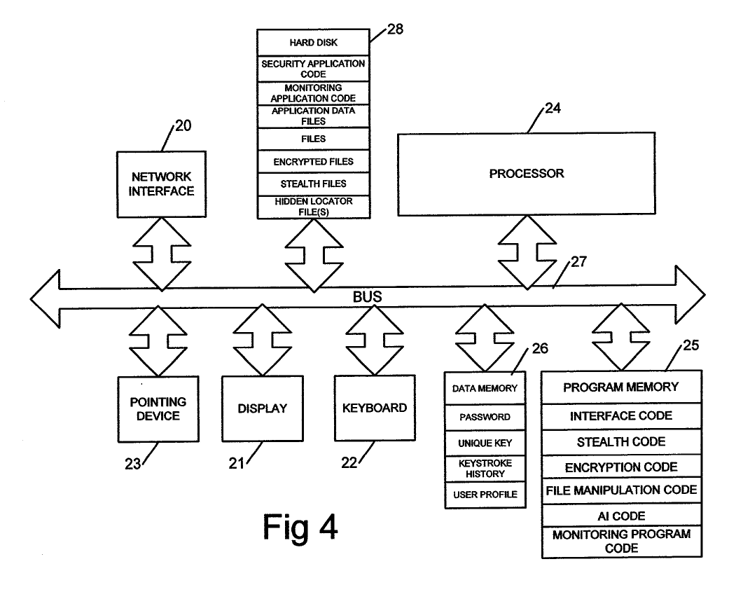

FIG. 4 is a schematic diagram of a security processing system in accordance with an embodiment of the present invention. In this embodiment of the present invention the security processing system comprises a suitably programmed general-purpose computer. The computer is provided with a network interface 20 to allow access to other computer systems. A pointing device 23, display 21 and keyboard 22 are provided to allow display of the graphical user interface and interaction by the user with the graphical user interface. A processor 24 is provided for reading and executing code stored in a program memory 25. The program memory 25 holds code being executed by the processor 24. The program memory 25 thus comprises volatile memory and stores code for providing the various functions of the security application. In this embodiment the code comprises interface face for generating the graphical user interface, stealth code for performing the obfuscation (stealth) process, encryption code for performing the encryption and decryption process, file manipulation code for performing file manipulation when a user selects the files within the file menu 1, artificial intelligence code for updating the user profiles, and monitoring program code for performing the monitoring operation to assist a user in securely storing files (as will be described in more detail hereinafter).

A data memory 26 is provided to store data being used by the processor 24 when executing the program code and program memory 25. The data memory holds the password, a unique key for the security application to be used for encrypting the record for stealth (obfuscated) files, key stroke history and user profile data.

A hard disk 28 is provided as a non volatile store to store the security application code which is loaded into the program memory 25, the monitoring application code which is also loaded into the program memory 25 for execution by the processor 24, application data files which include the password data, user profile data and unique key data, user files e.g. documents, spreadsheets etc, encrypted files, stealth files and the hidden locator files i.e. the stealth record file.

The operation of the security application in the computer will now be described.

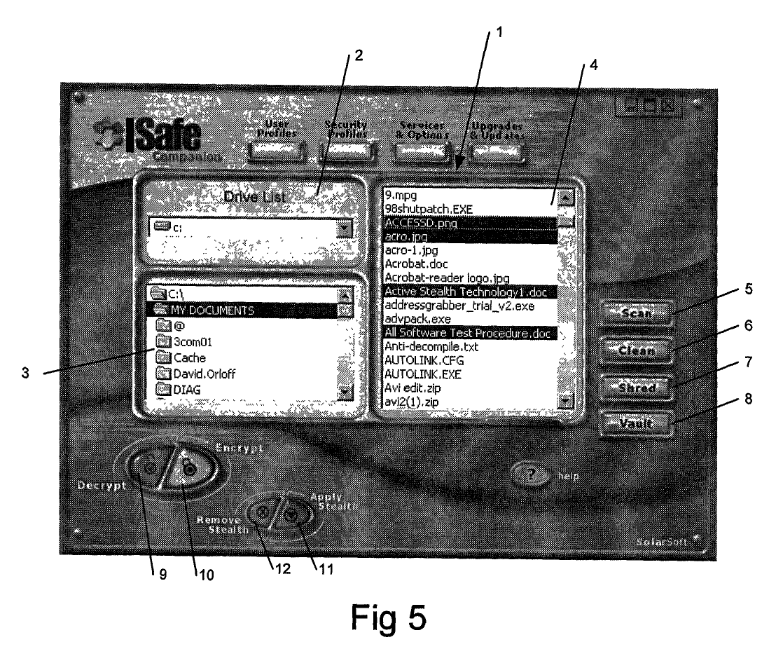

FIG. 5 is a screen shot of the graphical user interface showing the selection of four files under the directory “MY DOCUMENTS”. FIG. 5 also illustrates the selection of the encrypt button 10 as a result of the user requiring the encryption for these four selected files.

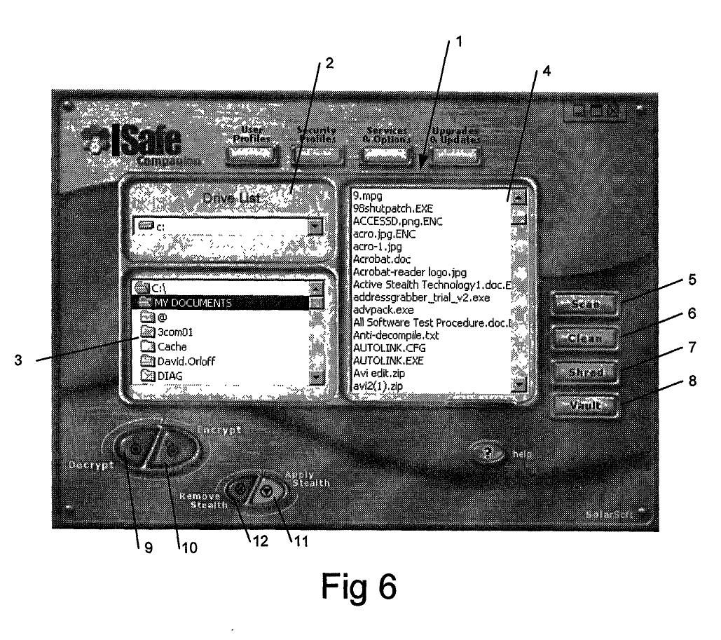

FIG. 6 is a screen shot illustrating the result of the encryption process. The four files are encrypted and given an additional file name extension .ENC. The encrypted files overwrite the original files and so there is thus no excess to the original information.

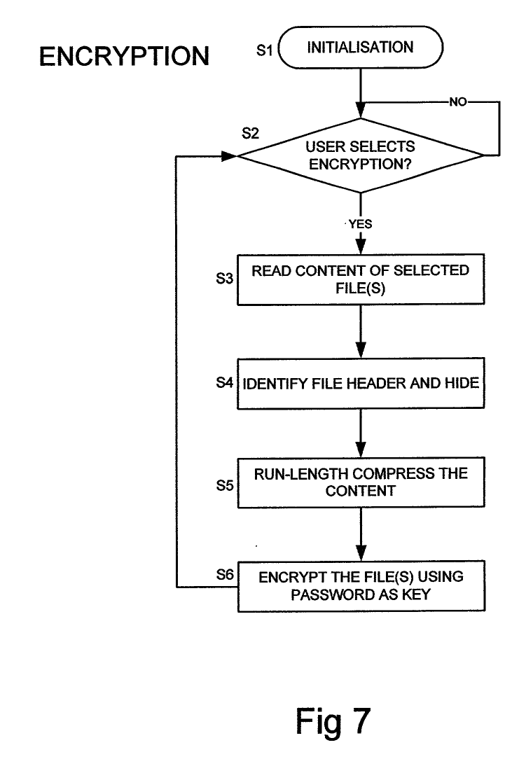

The encryption process will now be described with reference to the flow diagram of FIG. 7.

When the security application is initialised (step S1), the encryption process awaits the selection of the encrypt key 10 (step S2). When the user selects the encrypt key 10, the content of the selected file or files is read (step S3) and the file header in the file is identified and hidden (step S4). This hiding or obfuscation of the file header is important since it represents a recognisable pattern in a file. The file header can be modified in a known way, moved to another part of the file, or deleted. The modified file then undergoes run length compression (step S5). Run length compression is a technique well known in the art of video compression. Run length compression comprises identifying a number of consecutive data items in the data file which are identical or at least similar within certain bounds. Run length compression then comprises representing the consecutive data items i.e. the run by parameters indicating the parameter value and a number of data items, i.e. the run length. The run length compression technique is particularly useful for removing nulls in the data. Such recognisable patterns are a weakness in an encrypted file. Following compression of the file, the file is encrypted using the password (i.e. the pass phrase) as the key (step S6). Steps S4, S5 and S6 are repeated on a file by file basis on all the files until they are encrypted and the process then returns to step S2 to await selection of the encrypt key 10 again.

Thus this embodiment of the present invention provides a secure encryption process by which a compression process is carried out initially in order to remove recognisable patterns in the data before encryption. Although in this embodiment run length encoding is used, any sort of compression technique can be used as is well known in the video compression art. The additional modifications to the file header further enhance security.

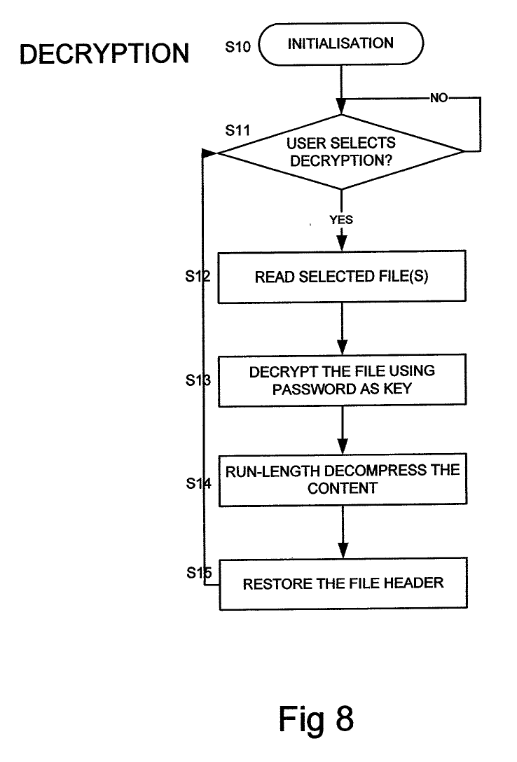

FIG. 8 is a flow diagram illustrating the decryption process which is the reverse of the encryption process. When the security application is initialised (step S10), the decryption process awaits selection of the decrypt button 9 by the user (step S11). When the decrypt button 9 is selected (step S11), the files selected by the user are read (step S12) and on a file by file basis, each file is decrypted using the password (i.e. pass phrase) as the key (step S13) and the decrypted content is run length decompressed (step S14). Finally, the file header is restored (step S15) and the file is thus restored.

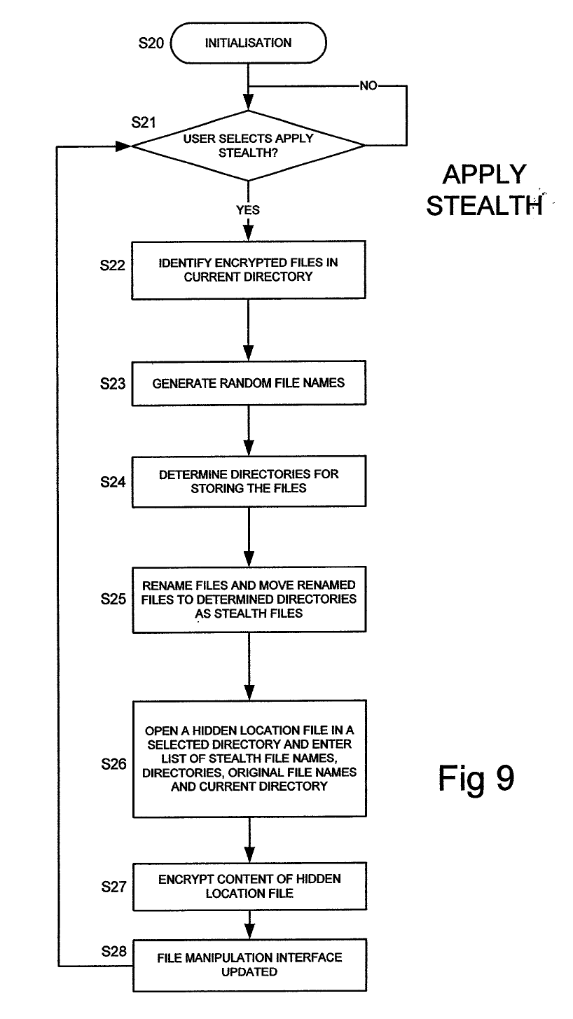

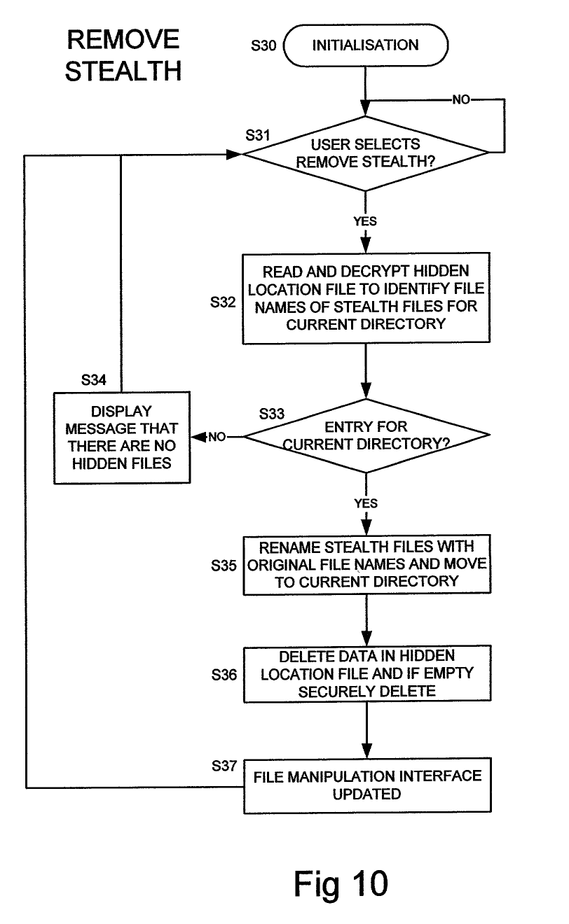

The method of applying and removing stealth in accordance with one embodiment of the present invention will now be described with reference to the flow diagrams of FIGS. 9 and 10.

FIG. 9 is a flow diagram illustrating a method of applying stealth, i.e. obfuscating files in accordance with the first embodiment of the present invention. Once the security application has been initialized (step S20) the stealth process awaits selection of the apply stealth button 11 (step S21). When a user selects the apply stealth button (step S21) encrypted files in the currently selected directory are identified (step S22). These files can be identified by simply looking for the file extension .ENC. The process then generates a random file name for each file to be stealthed (step S23). Also, a directory is determined for storing each of the files (step S24). The directory can comprise any obscure directory such as an operating system directory, or a program directory. The intention is to store the files with a name which is obscure in program or operating system files which frequently have obscure file names so as to obfuscate the file. Each file is then renamed and moved to the determined directories as stealth files (step S25). In order to keep a record of the location of stealthed (obfuscated) files, a hidden location file is opened in a selected directory and entries are made to list the stealth file names, the directories, the original file names and the current directory (step S26). This information can be entered as plain text. The content of the hidden location file is then encrypted (step S27) and the file manipulation interface, i.e. the file menu 1 is updated to show that the original files are no longer in the original directory (step S28). The encryption is performed using an encryption key which is generated during the installation of the security application. The security application generates a unique key by detecting unique parameters of the computer such as the hard disk serial number. This is used to generate a unique key for encryption. This unique key can either be stored for future encryption/decryption, or more securely, it can be dynamically generated each time encryption and decryption is required of the hidden location file. The hidden location file can be stored as any file name which is similar to an operating system file name and it is preferably stored in an operating system directory so as to obfuscate the file.

Thus in accordance with this embodiment of the present invention the files can be hidden by moving them and storing them in an obscure directory with an obscure file name. A secure record is kept in encrypted form, once again in an obscure file name in an obscure location, to enable the restoration of the original files in the original directory.

The process of restoration of the original files in the original directory will now be described with reference to FIG. 10. When the security application is initialized (step S30) the removed stealth process awaits selection of the remove stealth button 12 by the user (step S31). When a user selects the remove stealth button (step S31) the hidden location file is read and decrypted. The decryption of the hidden location file requires the unique key for the security application. This can either be read from memory if stored, or dynamically generated based on unique hardware parameters such as hard disk serial number. Once the hidden location file has been decrypted, the file names of the stealth files are identified by using the name of the current directory to look up stealth files for the current directory (step S32). If there is no entry in the hidden location file for the current directory (step S33) a message is displayed in the graphical user interface to inform the user there are no hidden (stealthed) files (step S34) and the process returns to step S31 to await a user selection of the remove stealth button 12. If there are entries for the current directory in the hidden location file (step S33) the stealth files are renamed with the original files names which are also stored in the hidden location file and the files are moved back to the current directory (step S35). The data for the current directory in the hidden location file is then deleted and if the hidden location file is empty, i.e. it is the only stealth file having a record in the hidden location file, the hidden location file is securely deleted, i.e. by repeatedly overwriting the storage location on the hard disk (step S36). The file manipulation interface, i.e. the file menu 1 in the graphical user interface is then updated (step S37) to show that the original files are now returned to the original directory.

Thus the apply stealth and remove stealth process removes the files from being visible in the current directory and returns them to be invisible respectively.

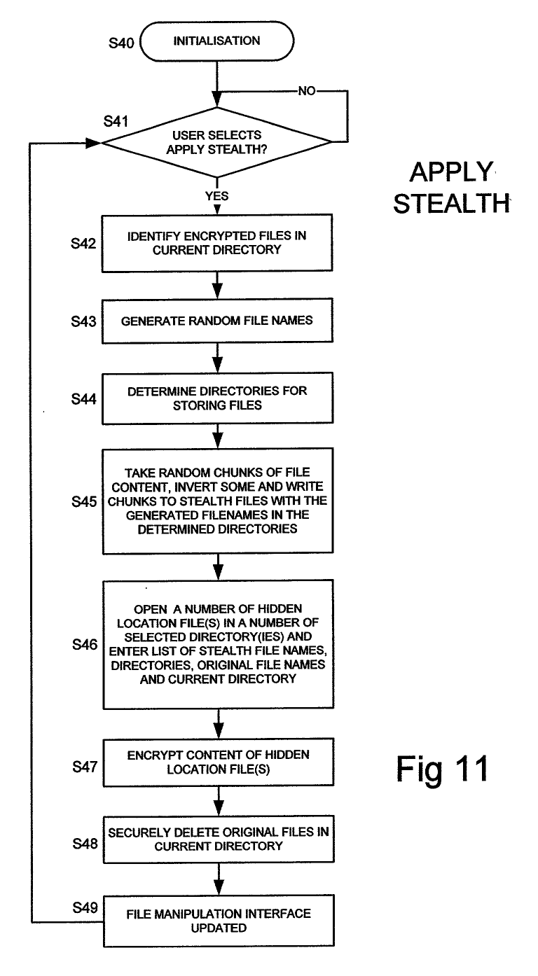

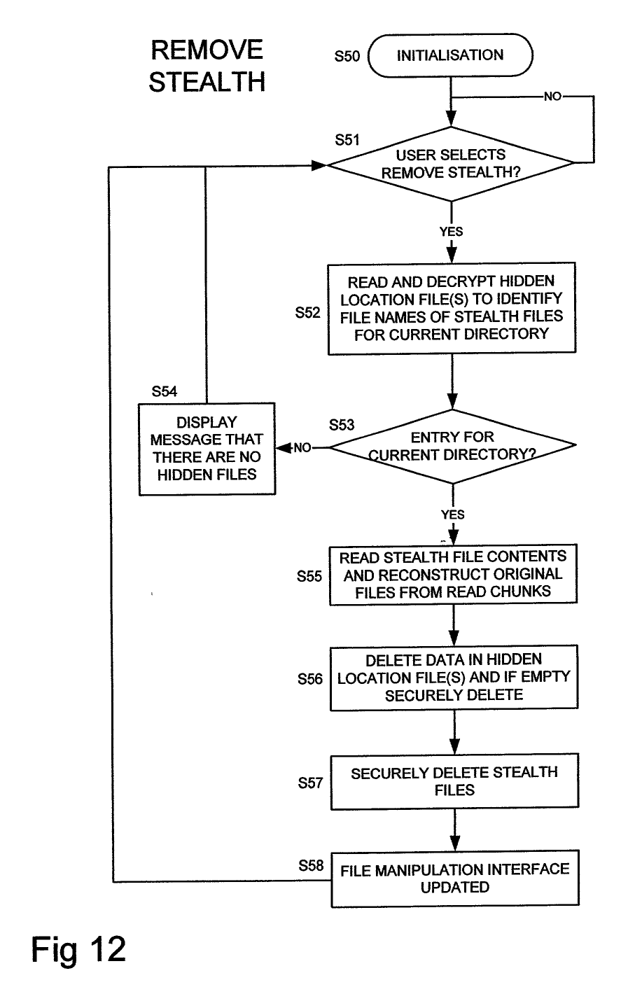

A second method of applying and removing stealth will now be described with reference to the flow diagrams of FIGS. 11 and 12. In this embodiment of the present invention stealth files comprise segments of the original file. The segments are stored in obscure locations, i.e. obscure directories or folders.

FIG. 11 is a flow diagram illustrating the process for applying stealth in accordance with this embodiment of the present invention. When the security application is initialized (step S40) the stealth process awaits selection of the apply stealth button 11 by the user (step S41). When a user selects the apply stealth button 11 (step S41) encrypted files in the current directory are identified (step S42). In this embodiment the encrypted files are identified by identifying all files with the file extension .ENC. The process then generates a number of random file names (step S43). These file names comprise obscure file names that would not indicate the content of the file. The process then determines a number of directories for storing files (step S44). Random chunks of file content are then taken and some of these chunks are inverted before being written to stealth files. The stealth files are given the generated random file names in the determined directories (step S45). A number of hidden location files are opened in a number of selected directories and these store the list of stealth file names, directories, original file names and the current directory (step S46). A single hidden location file can be generated to store the necessary information. The information will include the identity of the chunks that have been inverted so that the original file can be correctly reconstructed. Alternatively, a plurality of location files can be generated, some of them containing spoof data. If more than one hidden location file contains data, a master hidden location file will contain the location of the other hidden location files. The hidden location files are then encrypted (step S47). If there is only one encryption file this can be encrypted using a unique key which can either be stored following generation during the installation of the security application, or the key can be generated dynamically from unique hardware parameters such as the hard disk serial number. If there is more than one hidden location file, the master hidden location file can be encrypted using this unique key, and the content of the master hidden location file will include the key or half of the key for decrypting each of the other hidden location files. Each of the other hidden location files can thus contain half of the encryption key. Thus in order to remove stealth it will be necessary to decrypt each of the hidden location files using-the respective keys. This will be described in more detail with reference to the flow diagram of FIG. 12.

Following encryption of the hidden location files the original files in the current directory are securely deleted (step S48) and the file manipulation interface, i.e. the file menu 1 in the graphical user interface is updated (step S49).

The process for restoring the files by removing stealth will now be described with reference to the flow diagram of FIG. 12.

Following initialization of the security application (step S50) the remove stealth process awaits selection of the remove stealth button 12 by the user (step S51). When a user selects the remove stealth button 12 (step S51) the hidden location files are read and decrypted. If there is a single hidden location file, this is read and decrypted using the unique key for the security application. The unique key can be read from a secure storage location where it is stored following installation of the application, or it can be dynamically generated from unique information identifying the hardware, such as a hard disk serial number. If there is more than one hidden location file, following decryption of the master hidden location file, the content of the master hidden location file will identify the location of the other hidden location files and can include half of the encryption key necessary to decrypt them. A separate key can be used for hidden location file. Thus it is necessary to locate and read the other location files in order to accumulate all the information to restore the original files. Once all of the information has been retrieved by reading and decrypting the hidden location files, the file names of stealth files are identified using the name of the current directory. The current directory points to original file names which were stored in the current directory, file sizes, the file names of the stealth files generated for the original files, the directories in which the stealth files were stored, and information identifying whether any of the stealth files include inverted chunks of data.

If no entry is identified in the hidden location files for the current directory (step S53) a message is displayed in the graphical user interface to indicate to the user that there are no hidden files, i.e. no stealth files (step S54) and the process returns to step S51 to await the selection of the remove stealth button 12 by the user. If there are entries in the hidden location files for the current directory (step S53) the stealth file contents are read and on a file-by-file basis original files are constructed from the read chunks. Where necessary, the chunks are reinverted based on the information contained in the hidden location files (step S55). Data in the hidden location files for the current directory is then deleted and if this is the only entry in the hidden data files they are securely deleted (step S56). The stealth files are then securely deleted (step S57) and the file manipulation interface (i.e. the file menu 1) is updated (step S58) to show the return of the original files to the current directory. The process then returns to step S51) to await selection of the remove stealth button 12 by the user.

It can thus be seen that in this embodiment of the present invention an additional level of security is provided by not just using obscure file names and obscure directories in which to store the files, but also by segmenting the files in random chunks and distributing these across directories, it makes it further difficult for unauthorized access to the content of these files.

It can thus be seen from the foregoing description that the graphical user interface provided by the security application provides simply means by which a user can enter a user password and perform secure operations on files simply by selecting files and without having to enter in a password or pass phrase each time. The operation of accessing the graphical user interface of the security application by entry of the password provides access to the full functionality of encryption and obfuscation or stealthing of files without requiring tiresome entry of passwords each time. Thus the graphical user interface provides a simple security interface for a user of the security system.

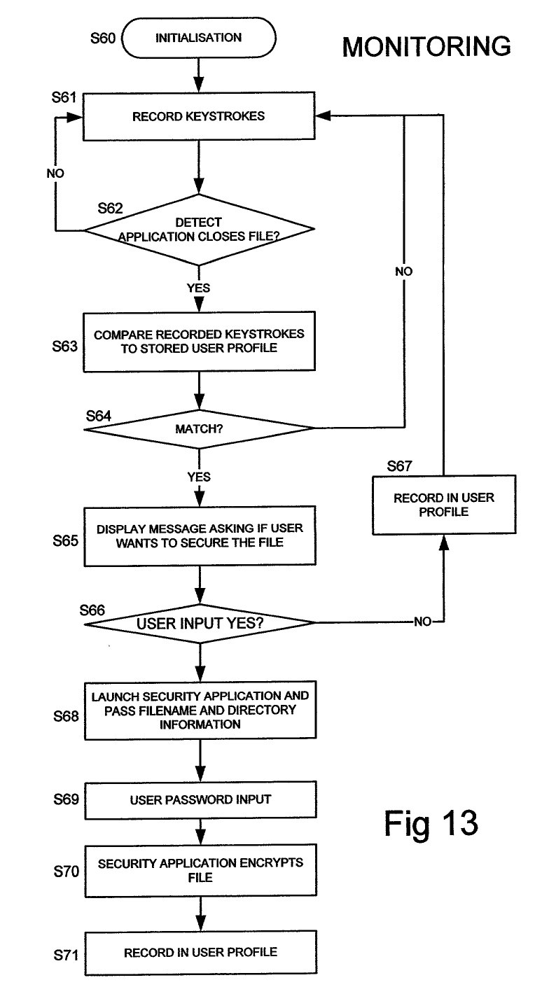

The method of assisting the user of a processing system to assist in secure storage of data will now be described with reference to the flow diagram of FIG. 13.

In this embodiment of the present invention a separate monitoring application is provided for providing this function. It can however be incorporated into the security application described hereinabove.

When the monitoring application is initialized (step S60) it continuously records keystrokes entered by a user during the processing of a file by an application (step S61). For example, when using a word processing application, a user will type in text and this is recorded. A monitoring application monitors applications into text when application close files (step S62), i.e. when an application finishes processing the file. When it is detected that an application has finished processing a file (step S62) the recorded keystrokes are compared to a stored user profile (step S63). The user profile can include keywords which have been stored for previous documents for which a user has requested encryption for security purposes. This comparison is performed by an artificial intelligence program. If there is no match between the recorded keystrokes and the stored user profile (step S64) the process returns to recording keystrokes (step S61) when a next application processes a file. If a match is found the graphical user interface generates a message asking the user if they want to secure the file, i.e. encrypt it (step S65). If a user selects not to secure the file (step S66) the artificial intelligence application records this selection and modifies the user profile accordingly (step S67) and the process returns to step S61 to record keystrokes in the next processing of a file by an application. Thus the artificial intelligence application is able to modify the user profile in accordance with previous user security history.

If a user selects to secure the file (step S66) the security application is launched and the file name of the file is passed to the security application together with the directory name (step S68). Within the security application, a user is required to enter their pass phrase (password) (step S69) and if successfully input, the security application will encrypt the file (step S70). The artificial intelligence application will then record the user selection in the user profile (step S71) in order to modify the encryption history for the user.

Thus in this embodiment of the present invention, a user can be prompted to securely store files such as documents after finishing processing on the document. This can avoid the unintentional security lapses by users i.e. by a user forgetting to encrypt a file with sensitive content.

Although the present invention has been described hereinabove with reference to specific embodiments, it will be apparent to a skilled person in the art that the modifications lie within the spirit and scope of the present invention.

In accordance with the present invention, the use of a password can comprise any string of alphanumeric characters. The string is preferably long to increase security and thus in the embodiments described hereinabove a pass phrase is used. It will thus be understood by a skilled person in the art that the term password encompasses pass phrase.

What is claimed is:

1. A method of securely computer encrypting content of a file, the method comprising compressing the content of the file, and encrypting the compressed content.

2. A method according to claim 1, wherein the compression is performed as run length encoding of the content of the file.

3. A method according to claim 1, including identifying a file header in the content of the file, and obfuscating the file header before encryption.

4. A method according to claim 3, wherein the obfuscation of the file header comprises modifying, moving or deleting the file header before encryption.

5. A method according to claim 1, wherein the encryption is performed using symmetric key encryption.

6. A method according to claim 5, wherein the encryption is performed using a user input password as the basis of an encryption key.

7. A method of securely computer decrypting content of an encrypted file, the method comprising decrypting the file content and decompressing the decrypted content of the file.

8. A method according to claim 7, wherein the decompression is performed as run length decoding of the decrypted content of the file.

9. A method according to claim 7, including identifying an obfuscated file header in the decrypted content of the file, and restoring the file header.

10. A method according to claim 9, wherein the restoration of the file header comprises modifying, moving or inserting the file header after decryption.

11. A method according to claim 7, wherein the decryption is performed using symmetric key decryption.

12. A method according to claim 11, wherein the decryption is performed using a user input password as the basis of a decryption key.

13. A method according to claim 7 for decrypting a file encrypted using the method of claim 1.

14. Apparatus for securely computer encrypting content of a file, the apparatus comprising compressing means for compressing the content of the file, and encrypting means for encrypting the compressed content.

15. Apparatus according to claim 14, wherein said compressing means is adapted to perform the compression as run length encoding of the content of the file.

16. Apparatus according to claim 14, including identifying means for identifying a file header in the content of the file, and obfuscating means for obfuscating the file header before encryption.

17. Apparatus according to claim 16, wherein said obfuscating means is adapted to modify, move or delete the file header before encryption.

18. Apparatus according to claim 14, wherein said encrypting means is adapted to perform symmetric key encryption.

19. Apparatus according to claim 18, wherein said encrypting means is adapted to perform the encryption using a user input password as the basis of an encryption key.

20. Apparatus for securely computer decrypting content of an encrypted file, the apparatus comprising decrypting means for decrypting the file content and decompressing means for decompressing the decrypted content of the file.

21. Apparatus according to claim 20, wherein said decompressing means is adapted to perform the decompression as run length decoding of the decrypted content of the file.

22. Apparatus according to claim 20, including identifying means for identifying an obfuscated file header in the decrypted content of the file, and restoring means for restoring the file header.

23. Apparatus according to claim 22, wherein said restoring means is adapted to modify, move or insert the file header after decryption.

24. Apparatus according to claim 20, wherein said decrypting means is adapted to perform decryption using symmetric key decryption.

25. Apparatus according to claim 24, wherein said decrypting means is adapted to perform decryption using a user input password as the basis of a decryption key.

26. A computer apparatus for securely computer encrypting content of a file, the apparatus comprising:
a program memory containing processor readable instructions; and
a processor for reading and executing the instructions contained in the program memory;
wherein said processor readable instructions comprise instructions for controlling the processor to carry out the method of any one of claims 1 to 6.

27. A carrier medium carrying computer readable instructions for controlling a computer to carry out the method of any one of claims 1 to 6.

28. A computer apparatus for securely computer decrypting content of an encrypted file, the apparatus comprising:
a program memory containing processor readable instructions; and
a processor for reading and executing the instructions contained in the program memory;
wherein said processor readable instructions comprise instructions for controlling the processor to carry out the method of any one of claims 7 to 13.

29. A carrier medium carrying computer readable instructions for controlling a computer to carry out the method of any one of claims 7 to 13.

30. A carrier medium carrying the content of a file encrypted using the method of any one of claims 1 to 6.

31. A method of obfuscating at least one file in a computer system, the method comprising:
automatically changing a filename of the or each file from an original file name to an obscure filename and moving the or each file from an original location to at least one obscure location;
keeping a record of the or each original filename and location and the or each corresponding obscure filename and location; and
encrypting the record.

32. A method according to claim 31, wherein the or each original location comprises a directory or folder and the or each obscure location comprises an obscure directory or folder.

33. A method according to claim 32, including initially receiving a user selection of the or each directory or folder.

34. A method according to claim 33, including initially receiving a user selection of the or each file.

35. A method according to claim 33, wherein the or each file is automatically determined.

36. A method according to claim 35, wherein any files of a file type in the or each directory or folder are automatically determined as the or each file.

37. A method according to claim 36, wherein any encrypted files in the or each directory or folder are automatically determined as the or each file.

38. A method according to claim 31, wherein the or each obscure filename is determined randomly or pseudo randomly.

39. A method according to claim 31, wherein the or each obscure directory or folder is an operating system directory or folder or a program directory or folder.

40. A method according to claim 31, wherein the encrypted record is stored as a hidden file.

41. A method of recovering at least one obfuscated file in a computer system, the method comprising:
reading and decrypting a record of at least one original filename and location and at least one corresponding obscure filename and location; and
automatically changing the filename of the or each obfuscated file from the or each obscure filename to the or each original filename and moving the or each file from the respective obscure location to the respective original location.

42. A method according to claim 41, wherein the or each original location comprises an original directory or folder and the or each obscure location comprises an obscure directory or folder.

43. A method according to claim 42, including initially receiving a user selection of the or each original directory or folder, identifying at least one corresponding obscure filename and directory or folder in the decrypted record using the user selection, and automatically changing the or each corresponding obscure filename to the or each original filename and moving the or each corresponding file from the respective obscure directory or folder to the respective original directory or folder.

44. A method according to claim 42, wherein the or each obscure directory or folder is an operating system directory or folder or a program directory or folder.

45. A method according to claim 41, wherein the encrypted record is a hidden file.

46. A method according to claim 41, wherein the or each file has been obfuscated using the method of claim 31.

47. Apparatus for obfuscating at least one file in a computer system, the apparatus comprising:
changing means for automatically changing a filename of the or each file from an original file name to an obscure filename and moving the or each file from an original location to at least one obscure location;
recording means for keeping a record of the or each original filename and location and the or each corresponding obscure filename and location; and
encrypting means for encrypting the record.

48. Apparatus according to claim 47, wherein the or each original location comprises a directory or folder and the or each obscure location comprises an obscure directory or folder.

49. Apparatus according to claim 48, including receiving means for initially receiving a user selection of the or each directory or folder.

50. Apparatus according to claim 49, wherein said receiving means is adapted to initially receive a user selection of the or each file.

51. Apparatus according to claim 49, including determining means for automatically determining the or each file in response to the user selection.

52. Apparatus according to claim 51, wherein said determining means is adapted to determine any files of a file type in the or each directory or folder as the or each file.

53. Apparatus according to claim 52, wherein said determining means is adapted to determine any encrypted files in the or each directory or folder as the or each file.

54. Apparatus according to claim 47, including means for determining the or each obscure filename randomly or pseudo randomly.

55. Apparatus according to claim 47, wherein the or each obscure directory or folder is an operating system directory or folder or a program directory or folder.

56. Apparatus according to claim 47, including storing means for storing the encrypted record as a hidden file.

57. Apparatus for recovering at least one obfuscated file in a computer system, the apparatus comprising:
decrypting means for reading and decrypting a record of at least one original filename and location and at least one corresponding obscure filename and location; and
changing means for automatically changing the filename of the or each obfuscated file from the or each obscure filename to the or each original filename and moving the or each file from the respective obscure location to the respective original location.

58. Apparatus according to claim 57, wherein the or each original location comprises an original directory or folder and the or each obscure location comprises an obscure directory or folder.

59. Apparatus according to claim 58, including receiving means for initially receiving a user selection of the or each original directory or folder, and identifying means for identifying at least one corresponding obscure filename and directory or folder in the decrypted record using the user selection, wherein said changing means is adapted to automatically change the or each corresponding obscure filename to the or each original filename and move the or each corresponding file from the respective obscure directory or folder to the respective original directory or folder.

60. Apparatus according to claim 58, wherein the or each obscure directory or folder is an operating system directory or folder or a program directory or folder.

61. Apparatus according to claim 57, wherein the encrypted record is a hidden file.

62. Apparatus according to claim 57, wherein the or each file has been obfuscated using the method of claim 31.

63. A computer apparatus for obfuscating at least one file in a computer system, the apparatus comprising:
a program memory containing processor readable instructions; and
a processor for reading and executing the instructions contained in the program memory;
wherein said processor readable instructions comprise instructions for controlling the processor to carry out the method of any one of claims 31 to 40.

64. A carrier medium carrying computer readable instructions for controlling a computer to carry out the method of any one of claims 31 to 40.

65. A computer apparatus for recovering at least one obfuscated file in a computer system, the apparatus comprising:
a program memory containing processor readable instructions; and
a processor for reading and executing the instructions contained in the program memory;
wherein said processor readable instructions comprise instructions for controlling the processor to carry out the method of any one of claims 41 to 46.

66. A carrier medium carrying computer readable instructions for controlling a computer to carry out the method of any one of claims 41 to 46.

67. A method of obfuscating information stored in a location in a computer system, the method comprising:
dividing the information into a plurality of segments and storing each segment in a new location;
keeping a record of the location of the information and corresponding new locations;
deleting the information; and
encrypting the record.

68. A method according to claim 67, wherein said segments are of a random or pseudo random size.

69. A method according to claim 67, including inverting at least one of said segments before storing in the or each new location.

70. A method according to claim 69, wherein said record stores information identifying which segments are stored inverted.

71. A method according to claim 67, including initially receiving a user selection of the location.

72. A method according to claim 71, including initially receiving a user selection of the information.

73. A method according to claim 71, wherein said information is determined automatically based on the user selection.

74. A method according to claim 67, wherein said information comprises a file having a filename, said location is identified by a directory or folder name, and said record includes said filename and directory or folder.

75. A method according to claim 74, wherein each segment is stored as a file having a new filename in another directory or folder, and said record includes said new filenames and other directories or folders.

76. A method according to claim 75, wherein the filename for each segment is randomly or pseudo randomly generated as an obscure filename and the directory or folder in which each segment is stored is an obscure directory or folder.

77. A method according to claim 74, wherein said segments are stored in a form not recognisable by an operating system.

78. A method according to claim 67, including encrypting the information before segmentation.

79. A method according to claim 78, wherein the information is encrypted using the method of claim 1.

80. A method according to claim 67, wherein the information comprises a plurality of information items, each information item being segmented, and said record includes the location of each information item and corresponding new locations of stored segments.

81. A method of restoring information obfuscated in a computer system, the method comprising:
reading and decrypting a record of an original location of the information and corresponding locations of segments of the information;
reading the segments of the information from the locations;
combining the segments of the information; and
storing the combined segments as the restored information in the original location.

82. A method according to claim 81, wherein said segments are of a random or pseudo random size.

83. A method according to claim 81, including inverting at least one of the read segments before combining segments as the restored information in the original location.

84. A method according to claim 83, wherein said record stores information identifying which segments are stored inverted.

85. A method according to claim 81, including initially receiving a user selection of the original location to identify the segments to be read from the record.

86. A method according to claim 81, wherein said information comprises a file having a filename, said original location is identified by a directory or folder name, and said record includes said filename and directory or folder.

87. A method according to claim 86, wherein each segment is stored as a file having a new filename in another directory or folder, and said record includes said new filenames and other directories or folders.

88. A method according to claim 87, wherein the filename for each segment is an obscure filename and the directory or folder in which each segment is stored is an obscure directory or folder.

89. A method according to claim 87, wherein said segments are stored in a form not recognisable by an operating system and are read by a sub operating system level operation.

90. A method according to claim 81 including decrypting the information after combination of the segments.

91. A method according to claim 90, wherein the information is decrypted using the method of claim 7.

92. A method according to claim 81, wherein the information comprises a plurality of information items, each information item being segmented, and said record includes the location of each information item and corresponding new locations of stored segments.

93. Apparatus for obfuscating information stored in a location in a computer system, the apparatus comprising:
dividing means for dividing the information into a plurality of segments and storing each segment in a new location;
recording means for keeping a record of the location of the information and corresponding new locations;
deleting means for deleting the information; and
encrypting means for encrypting the record.

94. Apparatus according to claim 93, wherein said dividing means is adapted to divide said information into said segments of a random or pseudo random size.

95. Apparatus according to claim 93, including inverting means for inverting at least one of said segments before storing in the or each new location.

96. Apparatus according to claim 95, wherein said recording means is adapted to store information identifying which segments are stored inverted.

97. Apparatus according to claim 93, including user selection means for initially receiving a user selection of the location.

98. Apparatus according to claim 97, wherein said user selection means is adapted to initially receive a user selection of the information.

99. Apparatus according to claim 97, including determining means for determining said information automatically based on the user selection.

100. Apparatus according to claim 93, wherein said information comprises a file having a filename, said location is identified by a directory or folder name, and said recording means is adapted to store the record to include said filename and directory or folder.

101. Apparatus according to claim 100, wherein said dividing means is adapted to store each segment as a file having a new filename in another directory or folder, and said recording means is adapted to store the record to include said new filenames and other directories or folders.

102. Apparatus according to claim 101, including means for generating the filename for each segment randomly or pseudo randomly as an obscure filename, wherein the directory or folder in which each segment is stored is an obscure directory or folder.

103. Apparatus according to claim 100, wherein said dividing means is adapted to store said segments in a form not recognisable by an operating system .

104. Apparatus according to claim 93, including information encrypting means for encrypting the information before segmentation.

105. Apparatus according to claim 104, wherein said information encrypting means is adapted to encrypt the information using the method of any one of claims 1 to 6.

106. Apparatus according to claim 93, wherein the information comprises a plurality of information items, said dividing means is adapted to segment each information item, and said recording means is adapted to include the location of each information item and corresponding new locations of stored segments in the record.

107. Apparatus for restoring information obfuscated in a computer system, the apparatus comprising:
record decrypting means for reading and decrypting a record of an original location of the information and corresponding locations of segments of the information;
reading means for reading the segments of the information from the locations;
combining means for combining the segments of the information; and
storing means for storing the combined segments as the restored information in the original location.

108. Apparatus according to claim 107, wherein said segments are of a random or pseudo random size.

109. Apparatus according to claim 107, including inverting means for inverting at least one of the read segments before combining segments as the restored information in the original location.

110. Apparatus according to claim 109, wherein said record stores information identifying which segments are stored inverted.

111. Apparatus according to claim 107, including user selection means for initially receiving a user selection of the original location to identify the segments to be read from the record.

112. Apparatus according to claim 107, wherein said information comprises a file having a filename, said original location is identified by a directory or folder name, and said record includes said filename and directory or folder.

113. Apparatus according to claim 112, wherein each segment is stored as a file having a new filename in another directory or folder, and said record includes said new filenames and other directories or folders.

114. Apparatus according to claim 113, wherein the filename for each segment is an obscure filename and the directory or folder in which each segment is stored is an obscure directory or folder.

115. Apparatus according to claim 113, wherein said segments are stored in a form not recognisable by an operating system and said reading means is adapted to read said segments by a sub operating system level operation.

116. Apparatus according to claim 107 including information decrypting means for decrypting the information after combination of the segments.

117. Apparatus according to claim 116, wherein said information decrypting means is adapted to decrypt the information using the method of any one of claims 7 to 13.

118. Apparatus according to claim 107, wherein the information comprises a plurality of information items, each information item being segmented, and said record includes the location of each information item and corresponding new locations of stored segments.

119. A computer apparatus for obfuscating information stored in a location in a computer system, the apparatus comprising:
a program memory containing processor readable instructions; and
a processor for reading and executing the instructions contained in the program memory;
wherein said processor readable instructions comprise instructions for controlling the processor to carry out the method of any one of claims 67 to 80.

120. A carrier medium carrying computer readable instructions for controlling a computer to carry out the method of any one of claims 67 to 80.

121. A computer apparatus for restoring information obfuscated in a computer system, the apparatus comprising:
a program memory containing processor readable instructions; and
a processor for reading and executing the instructions contained in the program memory;
wherein said processor readable instructions comprise instructions for controlling the processor to carry out the method of any one of claims 81 to 92.

122. A carrier medium carrying computer readable instructions for controlling a computer to carry out the method of any one of claims 81 to 92.

123. A method of operating a computer system to provide file security, the method comprising:
generating a password input interface requiring a password input;
comparing an input password with a stored password;
generating a graphical user interface displaying a file menu in dependence upon the comparison to allow a user to input a user selection of at least one file for encryption or decryption; and
encrypting or decrypting the or each selected file in response to the user selection using symmetric key encryption or decryption wherein the input password comprises the basis of the key for encryption or decryption.

124. A method according to claim 123, wherein the graphical user interface is generated with a selectable option to allow a user to input a user selection of at least one file to be obfuscate, including obfuscating the or each file in response to a user selection.

125. A method according to claim 124, wherein the graphical user interface is generated with a selectable option to allow a user to input a user selection to restore obfuscated files, including restoring obfuscated files in response to a user selection.

126. A method according to claim 125, wherein the selectable option allows a user to select a directory or folder as the input user selection to restore obfuscated files originally in the directory or folder, including restoring files in the selected directory or folder in response to a user selection.

127. A method according to claim 124, wherein the files are obfuscated using the method of claim 29.

128. A method according to claim 125, wherein the files are restored using the method of claim 39.

129. A method according to claim 123, wherein the or each selected file is encrypted using the method of claim 1.

130. A computer system for providing file security, the system comprising:
password input means for generating a password input interface requiring a password input;
comparing means for comparing an input password with a stored password;
user interface means for generating a graphical user interface displaying a file menu in dependence upon the comparison to allow a user to input a user selection of at least one file for encryption or decryption; and
encrypting means for encrypting or decrypting the or each selected file in response to the user selection using symmetric key encryption or decryption wherein the input password comprises the basis of the key for encryption or decryption.

131. A computer system according to claim 130, wherein said user interface means is adapted to generate the graphical user interface with a selectable option to allow a user to input a user selection of at least one file to be obfuscate, including obfuscating means for obfuscating the or each file in response to a user selection.

132. A computer system according to claim 131, wherein said user interface means adapted to generate the graphical user interface with a selectable option to allow a user to input a user selection to restore obfuscated files, including restoring means for restoring obfuscated files in response to a user selection.

133. A computer system according to claim 132, wherein said user interface means is adapted to generate the graphical user interface with the selectable option to allow a user to select a directory or folder as the input user selection to restore obfuscated files originally in the directory or folder, and said restoring means is adapted to restore files in the selected directory or folder in response to a user selection.

134. A computer system according to of claim 130, wherein said means is adapted to obfuscate the files using the method of any one of claims 29 to 38.

135. A computer system according to claim 130, wherein said restoring means is adapted to restore the files using the method of any one of claims 39 to 44.

136. A computer system according to claims 130, wherein said encrypting means is adapted to encrypt the or each file using the method of any one of claims 1 to 6.

137. A computer system for providing file security, the system comprising:
a program memory containing processor readable instructions; and
a processor for reading and executing the instructions contained in the program memory;
wherein said processor readable instructions comprise instructions for controlling the processor to carry out the method of any one of claims 123 to 129.

138. A carrier medium carrying computer readable instructions for controlling a computer to carry out the method of any one of claims 123 to 129.

139. A method of assisting an operator of a processing system, the method comprising:
monitoring user inputs to the processing system during processing of a file by a processing application;
detecting when a processing application has finished processing a file;
comparing monitored user inputs to a user profile;
generating a user interface in dependence upon the comparison to allow the user to select to encrypt the file; and
encrypting the file in dependence upon the user selection.

140. A method according to claim 139, wherein said monitored user inputs comprise keystrokes, and the comparison comprises comparing the monitored keystrokes with words in the user profile.

141. A method according to claim 139, including modifying the user profile based on previous encryption selections.

142. A method according to claim 139, wherein the file is encrypted using the method of claim 1.

143. A processing system for providing operator assistance, the system comprising:
monitoring means for monitoring user inputs to the processing system during processing of a file by a processing application;
detecting means for detecting when a processing application has finished processing a file;
comparing means for comparing monitored user inputs to a user profile;
generating means for generating a user interface in dependence upon the comparison to allow the user to select to encrypt the file; and
encrypting means for encrypting the file in dependence upon the user selection.

144. A system according to claim 143, wherein said monitoring means is adapted to monitor keystrokes, and said comparing means is adapted to compare the monitored keystrokes with words in the user profile.

145. A system according to claim 143, including means for modifying the user profile based on previous encryption selections.

146. A system according to claim 143, wherein said encryption means is adapted to encrypt the file using the method of claim 1.

147. A processing system for providing operator assistance, the system comprising:
a program memory containing processor readable instructions; and
a processor for reading and executing the instructions contained in the program memory;
wherein said processor readable instructions comprise instructions for controlling the processor to carry out the method of any one of claims 139 to 142. 148. A carrier medium carrying computer readable instructions for controlling a computer to carry out the method of any one of claims 139 to 142.
